(19) United States
(12) Patent Application Publication
(10) Pub. No.: US 2022/0081352 A1
(43) Pub. Date: Mar. 17, 2022

(54) GLASS PLATE COATED WITH IMPACT PROTECTION FILM LAYER

(71) Applicant: CHENFENG OPTRONICS CORPORATION, Taichung City (TW)

(72) Inventors: CHING-FANG WONG, Taichung City (TW); YU-WEI LIU, Taichung City (TW); WEI-LUN ZENG, Taichung City (TW); KUAN-HUA LIAO, Taichung City (TW)

(21) Appl. No.: 17/474,611

(22) Filed: Sep. 14, 2021

(30) Foreign Application Priority Data
Sep. 14, 2020 (TW) 109131574

(51) Int. Cl. C03C 17/32; C09D 11/108; C09D 11/037; C09D 11/033

(52) U.S. Cl. CPC C03C 17/32; C09D 11/108; C03C 2217/78; C09D 11/033; C09D 11/037

(57) ABSTRACT

A glass plate coated with an impact protection film layer is made by coating an impact protection film layer onto a surface of the glass plate. The impact protection film layer is made of a phenyl-containing macromolecular polymer, which has a monomer carbon chain length of between C6 and C18. The coated glass plate is shock-cushioning and impact-proof, and is thereby protected against damage caused by impact from an external force.

### BACKGROUND OF THE INVENTION

### 1. Field of the Invention

The present invention relates to glass, and more particularly to a glass plate coated with an impact protection film layer.

### 2. Description of the Related Art

Glass plates are extensively used in our daily life in the form of, for example, screens of portable electronics, panels of vehicle electronic display devices, and protective glass for displays.

However, glass plates are hard and brittle in nature. Without protection, they can be easily damaged or broken under impact caused by external forces. Hence, how to make glass plates impact-proof is an issue to be addressed.

### SUMMARY OF THE INVENTION

To address the aforementioned issue, the present invention discloses a glass plate coated with an impact protection film layer, wherein the impact protection film protects the glass plate form damaged under impact caused by external forces.

In one embodiment, the present invention provides a glass plate coated with an impact protection film layer, being made by forming the impact protection film layer on one surface of the glass plate, the impact protection film layer being made of a phenyl-containing macromolecular polymer, which has a monomer carbon chain length of between C6 and C18.

In another embodiment of the present invention, before cured on the surface, the impact protection film layer is added with a mixture of alcohols, ethers, epoxy resins, silicon dioxide and/or auxiliaries.

In another embodiment of the present invention, the impact protection film layer is applied to the surface and then baked to cure at a high temperature.

In another embodiment of the present invention, the auxiliaries include a surface antifoaming agent or a leveling agent.

In another embodiment of the present invention, the impact protection film layer further contains printing ink, and a ratio of the phenyl-containing macromolecular polymer and the mixture to the printing ink is of 5˜30%.

In another embodiment of the present invention, impact protection film layer has a honeycomb structure.

In another embodiment of the present invention, the glass plate has a transmittance of 85% or more.

In another embodiment of the present invention, the transmittance of the glass plate is of between 85% and 95%.

In another embodiment of the present invention, the impact protection film layer has a thickness of between 3 and 50 μm.

In another embodiment of the present invention, the glass plate has a first surface and a second surface opposite to the first surface, and the surface is the first surface or include the first surface and the second surface.

Thereby, the glass plate of the present invention is made shock-cushioning and impact-proof, and is thereby protected against damage caused by impact from an external force.

### BRIEF DESCRIPTION OF THE DRAWINGS

FIG. 1 is a cross-sectional view of a first embodiment of the present invention, showing an impact protection film layer formed on the first surface.

FIG. 2 is a cross-sectional view of a second embodiment of the present invention, showing an impact protection film layer formed on both the first surface and the second surface.

FIG. 3 is a cross-sectional view of a third embodiment of the present invention, showing an impact protection film layer formed along the periphery of the first surface.

FIG. 4 is a cross-sectional view of a fourth embodiment of the present invention, showing the impact protection film layer having a honeycomb structure.

### DETAILED DESCRIPTION OF THE INVENTION

Some exemplary embodiments of the present invention will be detailed with reference to the accompanying drawings. However, the technical principles on which the present invention is based are not limited to these specific embodiments. Instead, the scope of the present invention shall only be defined by the appended claims, including all their substitutes, modifications and equivalents.

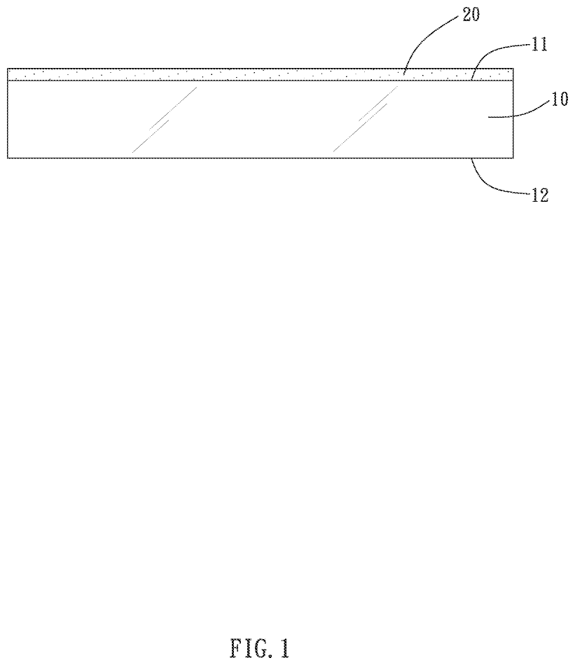

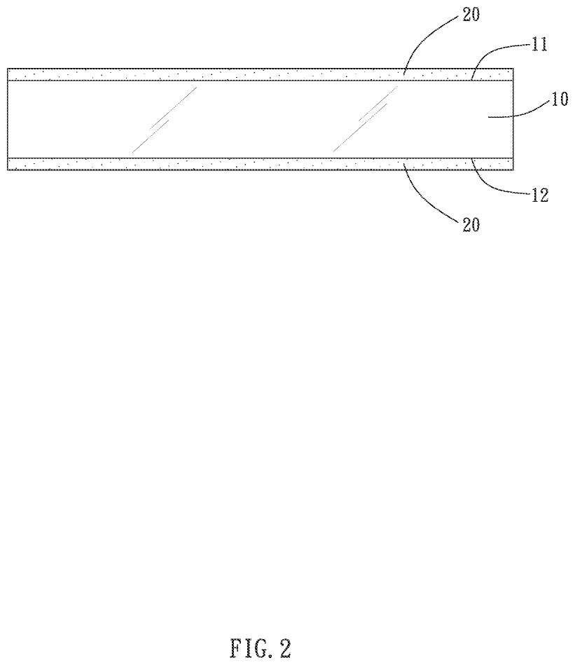

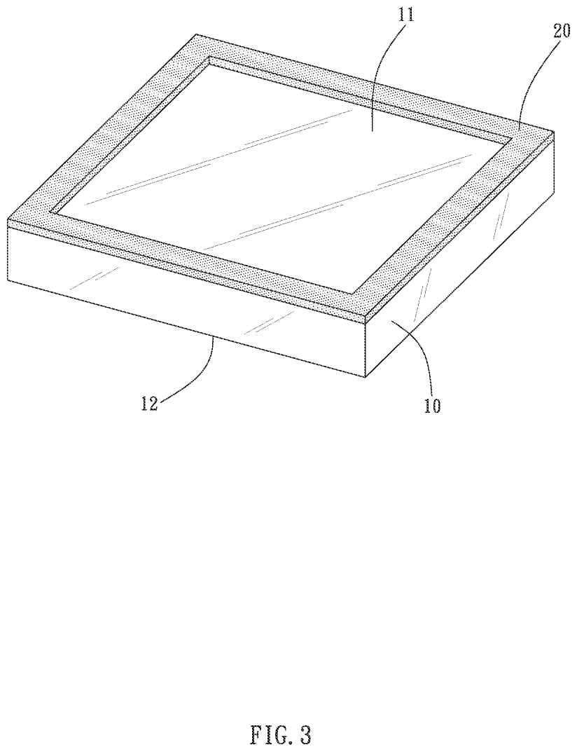

Please refer to FIG. 1 for the first embodiment of the present invention. The present invention herein is a glass plate 10 coated with an impact protection film layer 20, which has a first surface 11 and a second surface 12 opposite to the first surface H. One of the surfaces of the glass plate 10 is provided with an impact protection film layer 20. The impact protection film layer 20 is made of phenyl-containing macromolecular polymer, which has a monomer carbon chain length of between C6 and C18. As known, a polymer or a macromolecular compound typically, has a molecular weight a greater than 10,000 Dalton. Thus, in the embodiment of the present invention, the phrase “monomer carbon chain length” refers to the length of a carbon chain of a monomer forming the phenyl-containing macromolecular polymer. In the embodiment of the present invention, the foregoing surface is the first surface 11. In other words, the impact protection film layer 20 is only formed on the first surface 11. As shown in FIG. 2, the foregoing surface may alternatively include the first surface 11 and the second surface 12, which means that the impact protection film layer 20 is formed on both the first surface 11 and the second surface 12. As shown in FIG. 3, as a further alternative, the impact protection film layer 20 may be formed along the periphery of the first surface 11. Hence, it is contemplated in the present invention that the surface(s) of the glass plate 10 may be entirely or partially coated with the impact protection film layer 20 and thereby made impact proof according to practical needs.

It is to be noted that if a phenyl-containing macromolecular polymer having a monomer carbon chain length of below C6 is used as the coating, the resulting form can be too brittle, while a phenyl-containing macromolecular polymer having a monomer carbon chain length of above C18 can have problems in forming an effective structure. Therefore, in various embodiments of the present invention, the phenyl-containing macromolecular polymer preferably has a monomer carbon chain length of between C6 and C18 to provide good impact-proof and shock-cushioning properties.

As proven in experiments, with the impact protection film layer 20, the glass plate 10 of the present invention is 800% more resist to impact as compared to normal glass that does not have the impact protection film layer.

In the embodiment of the present invention, in addition to the phenyl-containing macromolecular polymer, the impact protection film layer 20 further contains a mixture that is added before the impact protection film layer 20 is cured on the surface. The mixture may be any one substance 1.0 of or a combination of any two or more substances selected from alcohols, ethers, epoxy resins, silicon dioxide, and auxiliaries. Therein, the alcohols and the ethers are used as a substrate for the coating solution, and mixed with the phenyl-containing macromolecular polymer to form a liquid that is easily applied across the surface of the underlying glass plate. The epoxy resins are for improving the resulting coating in terms of toughness and adhesion to glass. Silicon dioxide is used herein as an intermediary material that facilitates binding of the impact protection film layer 20 to the glass plate. The auxiliaries may include a surface antifoaming agent and a leveling agent, for preventing the impact protection film layer 20 from degrading the transmittance of the glass due to bubbling or unevenness. Therein, the impact protection film layer 20 is applied on to the surface and then baked to cure at a high temperature, such that the high temperature makes the macromolecular polymer undergo a cross-linking reaction, which creates bonding between the coating and the glass and removes any solvent contained in the coating. In the present embodiment, the baking is performed at a temperature of between 150° C. and 180° C. for a period of between 25 and 40 minutes. It is to be noted that, however, the baking is for drying and curing the film layer, and its implementation may vary according to the properties and concentration of materials used. The ranges given above are just illustrative and shall not form limitations to the present invention.

In the embodiment of the present invention, after the impact protection film layer 20 is formed on the glass plate 10, the glass plate 10 has a transmittance of 85% or more, such as between 85% and 95%, so that the formation of the impact protection film layer 20 does not decrease the transmittance of the glass plate 10. In addition, impact protection film layer 20 preferably has a thickness of between 3 and 50 μm, as being too thick can undesirably lead to a decreased transmittance of the glass plate 10.

Therefore, the present invention makes the glass plate 10 impact-proof and shock-cushioning by equipping it with the impact protection film layer 20. The coated glass plate 10 is thus less likely to be damaged by impact caused by external forces, and is more applicable to various applications, making the resulting products more competitive.

Referring to FIG. 3, the impact protection film layer 20 may be formed along the periphery of the first surface 11, and the materials of the impact protection film layer 20 include printing ink, so as to form a shielded area along the periphery of the first surface 11 of the glass plate 10. To this end, the ratio of the phenyl-containing macromolecular polymer and the mixture to the printing ink is of 5˜30%. In other words, the weight of the combination of the phenyl-containing macromolecular polymer and the mixture takes up 5˜30% of the total weight of the materials of the impact protection film layer 20, while the printing ink makes up rest of the total weight.

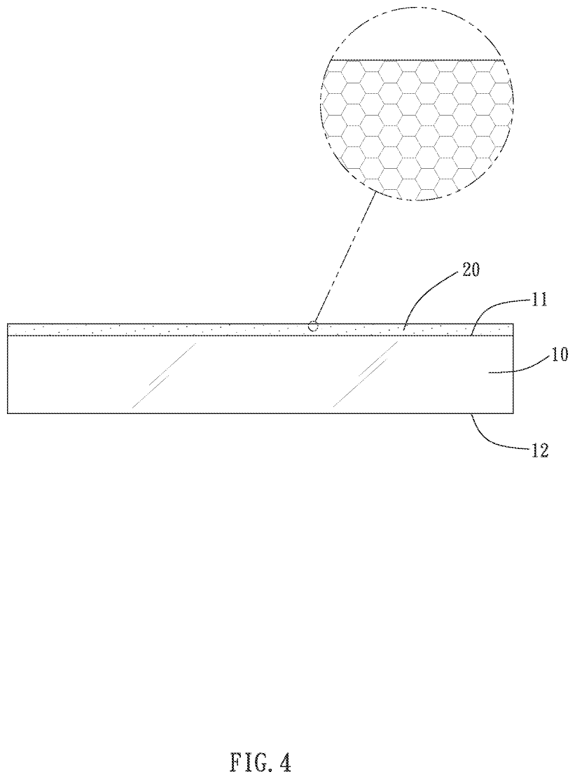

Referring to FIG. 4, in the present invention, the impact protection film layer 20 may have a honeycomb structure. During the process where the uncured materials of the impact protection film layer 20 are heated, CO2 and CO form and are encapsuled in the formed coating. The honeycomb structure so formed endows the glass plate 10 with impact-proof and shock-cushioning effects and properties.

To sum up, with the impact protection film layer 20 coated on its surface, the disclosed glass plate 10 becomes shock-cushioning and is thereby protected against damage caused by impact from an external force.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A glass plate coated with an impact protection film layer, being made by forming the impact protection film layer on one surface of the glass plate, the impact protection film layer being made of a phenyl-containing macromolecular polymer, which has a monomer carbon chain length of between C6 and C18.

2. The glass plate of claim 1, wherein before cured on the surface, the impact protection film layer is added with a mixture of alcohols, ethers, epoxy resins, silicon dioxide and/or auxiliaries.

3. The glass plate of claim 2, wherein the impact protection film layer is applied to the surface and then baked to cure at a high temperature.

4. The glass plate of claim 2, wherein the auxiliaries include a surface antifoaming agent or a leveling agent.

5. The glass plate of claim 2, wherein the impact protection film layer further contains printing ink, and a ratio of the phenyl-containing macromolecular polymer and the mixture to the printing ink is of 5˜30%.

6. The glass plate of claim 1, wherein the impact protection film layer has a honeycomb structure.

7. The glass plate of claim 1, wherein the glass plate has a transmittance of 85% or more.

8. The glass plate of claim 7, wherein the transmittance of the glass plate is of between 85% and 95%.

9. The glass plate of claim 1, wherein the impact protection film layer has a thickness of between 3 and 50 μm.

10. The glass plate of claim 1, wherein the glass plate has a first surface and a second surface opposite to the first surface, and the surface is the first surface or include the first surface and the second surface.
